(19) United States
(12) Patent Application Publication
(10) Pub. No.: US 2011/0084593 A1
(43) Pub. Date: Apr. 14, 2011

(54) LED ILLUMINATING DEVICE

(75) Inventors: Shao-Han Chang, Tu-Cheng (TW); Wen-Hsiang Lu, Tu-Cheng (TW)

(73) Assignee: HON HAI PRECISION INDUSTRY CO., LTD., Tu-Cheng (TW)

(21) Appl. No.: 12/768,691

(22) Filed: Apr. 27, 2010

(30) Foreign Application Priority Data
Oct. 9, 2009 (CN) 200910308109.0

(51) Int. Cl. H01J 5/48

(52) U.S. Cl. 313/318.01

(57) ABSTRACT

An LED illuminating device includes a first LED illuminating module, a second LED illuminating module, and a connecting module. The first LED illuminating module includes a first substrate and a first group of LEDs mounted on the first substrate. The second LED illuminating module includes a second substrate and a second group of LEDs mounted on the second substrate. The first group of LEDs and the second group of LEDs face opposite directions. The projections of the first substrate and the second substrate are spaced to each other. The connecting module connects the first LED illuminating module with the second illuminating module. The LED illuminating device has a large light divergence angle and good heat dissipation ability.

### CROSS-REFERENCE TO RELATED APPLICATIONS

Related subject matter is disclosed in co-pending U.S. Patent Applications of Attorney Docket No.US29300, entitled “LED ILLUMINATING DEVICE”, and Attorney Docket No.US29301, entitled“LED ILLUMINATING DEVICE”, which have the same inventors and assignees as named herein. The above-identified applications are incorporated herein by reference.

### BACKGROUND

1. Technical Field

The present disclosure relates to illuminating devices and, particularly, to a light emitting diode (LED) illuminating device.

2. Description of Related Art

Compared to traditional illuminating devices, LED lights have many advantages such as high luminous efficiency, low radiation, power saving, long life, etc. Yet, LED lights still have disadvantages. Because light emitted by LEDs is directional, light divergence angle of the LED light is less than that of the traditional illuminating device. Referring to FIG. 16, the light divergence angle of the traditional light source is S1, the value of S1 is about 160 degrees. Referring to FIG. 17, the light divergence angle of an LED is S2, the value of S2 is about 60 degrees.

People have combined several LEDs in a single LED illuminating device to enlarge the light divergence angle of the LED illuminating device. Referring to FIG. 18, a ring shaped LED illuminating device using many substrates 10 is shown. Each substrate 10 carries LEDs 11. The light divergence angle of the LED illuminating device is enlarged, yet, more heat is produced by the LEDs 11 (shown as arrows) between the substrates 10, which makes the LED illuminating devices become too hot.

Thus, what is needed is a LED illuminating device with large light divergence angle and good heat dissipation ability.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, cross-sectional view of an LED illuminating device according to a first embodiment.

FIG. 2 is a schematic, plan view showing substrates of the LED illuminating device of FIG. 1.

FIG. 3 is a schematic, cross-sectional view showing heat dissipation of the LED illuminating device of FIG. 1.

FIG. 4 are enlarged, cross-sectional views showing different transparent covers of the LED illuminating device of FIG. 1.

FIG. 5 is a schematic, cross-sectional view showing light characteristics of the LED illuminating device of FIG. 1.

FIG. 6 is a light distribution curve chart of the LED illuminating device of FIG. 1.

FIG. 7 is a schematic, cross-sectional view showing light characteristics of an LED illuminating device according to a second embodiment.

FIG. 8 is a light distribution curve chart of the LED illuminating device of FIG. 7.

FIG. 9 is a schematic, cross-sectional view showing light characteristics of an LED illuminating device according to a third embodiment.

FIG. 10 is a light distribution curve chart of the LED illuminating device of FIG. 9.

FIG. 11 is a schematic, cross-sectional view showing light characteristics of an LED illuminating device according to a forth embodiment.

FIG. 12 is a light distribution curve chart of the LED illuminating device of FIG. 11.

FIG. 13 is a schematic, cross-sectional view showing using the LED illuminating device of FIG. 11 as a ceiling lamp.

FIG. 14 is a schematic, cross-sectional view showing light characteristics of an LED illuminating device according to a fifth embodiment.

FIG. 15 is a light distribution curve chart of the LED illuminating device of FIG. 14.

FIG. 16 is a schematic view showing the light divergence angle of a traditional light source.

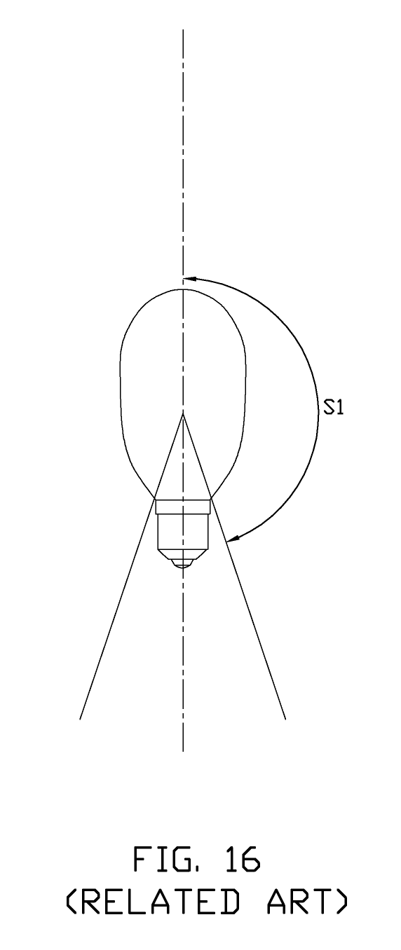

FIG. 17 is a schematic view showing the light divergence angle of an LED in related art.

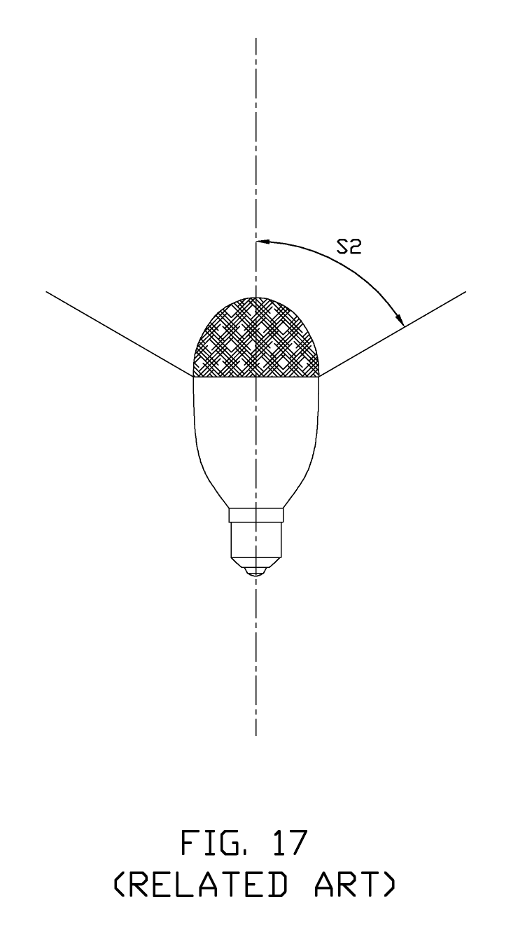

FIG. 18 is a schematic view showing heat dissipation of a ring shaped LED illuminating device in related art.

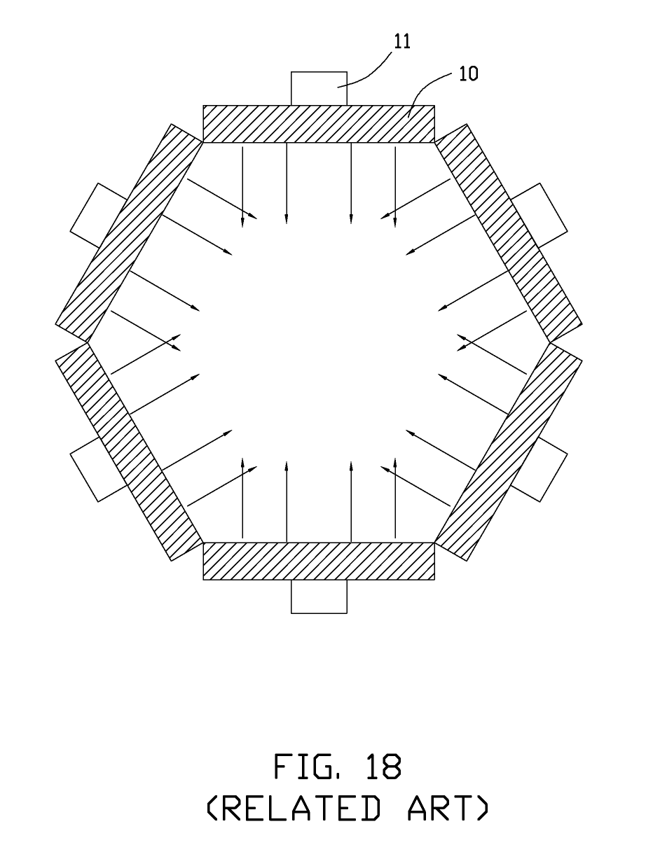

FIG. 19 is a schematic, cross-sectional view showing lighting characteristics of a first kind of traditional LED illuminating device.

FIG. 20 is a light distribution curve chart of the LED illuminating device of FIG. 19.

FIG. 21 is a schematic, cross-sectional view showing light characteristics of a second king of traditional LED illuminating device.

FIG. 22 is a light distribution curve chart of the LED illuminating device of FIG. 21.

FIG. 23 is a schematic, cross-sectional view showing light characteristics of a third kind of traditional LED illuminating device.

FIG. 24 is a light distribution curve chart of the LED illuminating device of FIG. 23.

### DETAILED DESCRIPTION

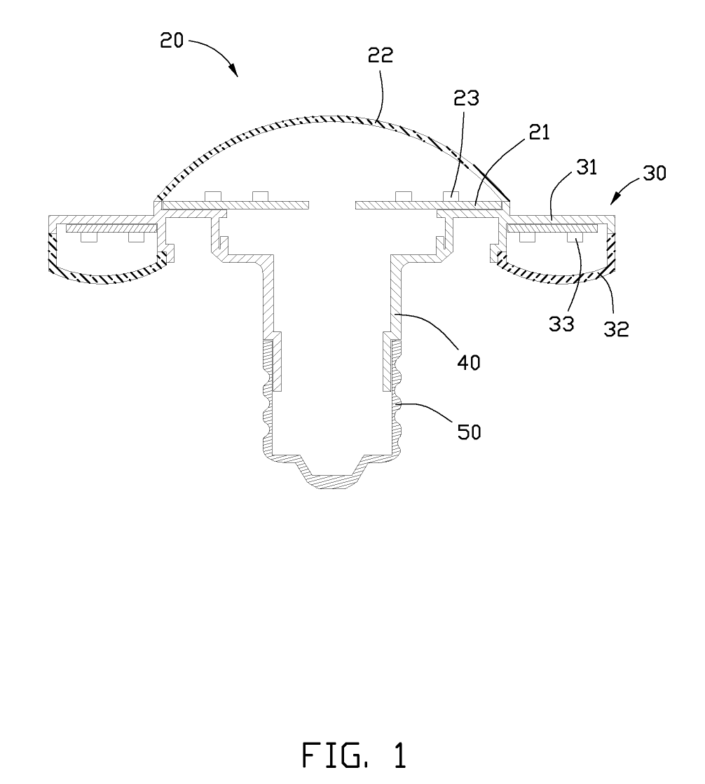

Referring to FIG. 1, an LED illuminating device according to a first embodiment is disclosed. The LED illuminating device includes a first illuminating module 20, a second illuminating module 30, a connecting module 40, and a power input module 50.

The first illuminating module 20 includes a first substrate 21 and a transparent first cover 22. The substrate 21 is mounted on the connecting module 40, and the transparent cover 22 is mounted on the substrate 21. The transparent cover 22 and the substrate 21 together form a first shell. A first group of LEDs 23 is mounted on the substrate 21 in the first shell.

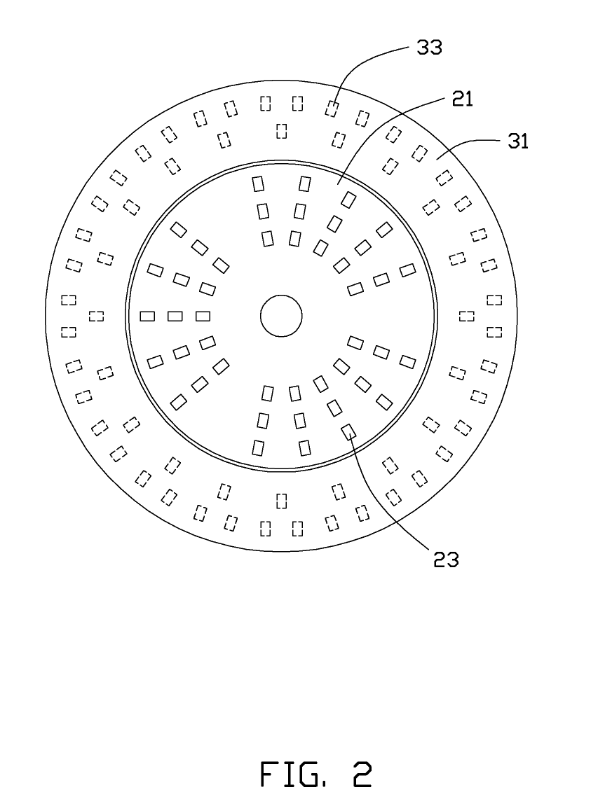

The second illuminating module 30 includes a second substrate 31 and a transparent second cover 32. The substrate 31 is mounted on the connecting module 40. The transparent cover 32 is mounted on the substrate 31. The transparent cover 32 and the substrate 31 together form a second shell. A second group of LEDs 33 is mounted on the substrate 31 in the second shell. Referring to FIG. 2, the projections of the first substrate 21 and the second substrate 31 are spaced from each other.

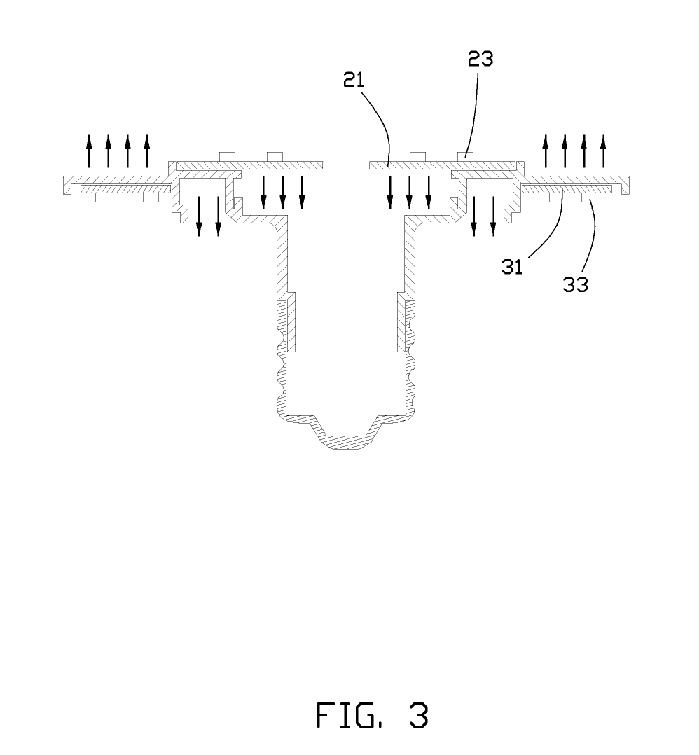

The first substrate 21 and the second substrate 31 face opposite directions, accordingly, the first group of LEDs 23 and the second group of LEDs 33 also face opposite directions. Referring to FIG. 3, heat produced by the LEDs 23, 33 and the substrates 21, 31 widely radiate along opposite directions, thus heat radiation efficiency is improved.

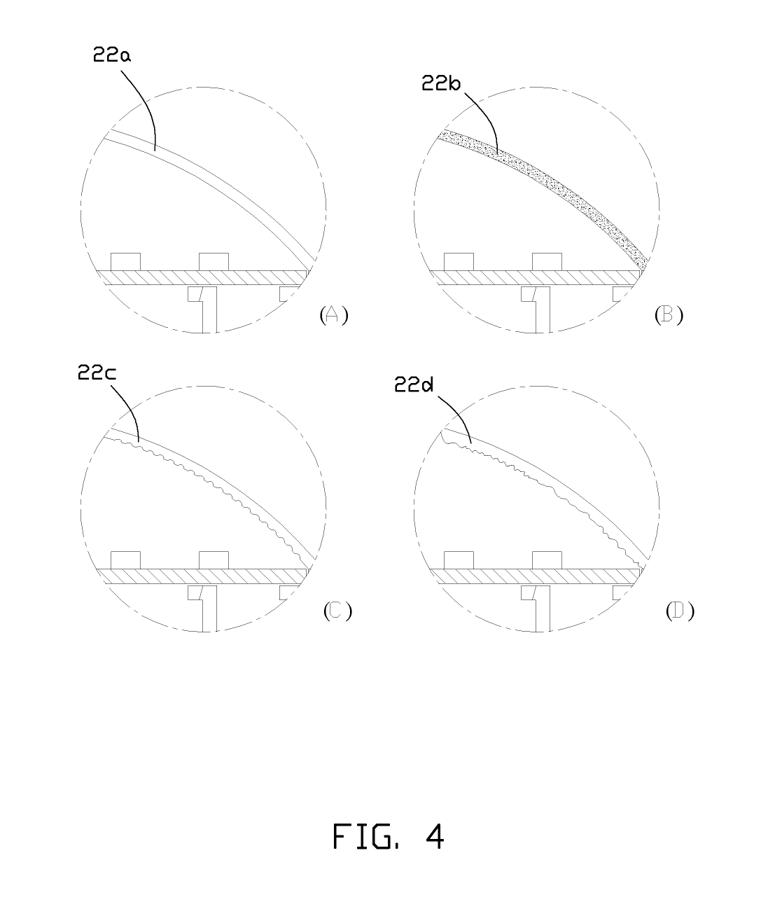

The transparent covers 22, 32 may be varied in shape and structure to achieve different illumination effects. Referring to FIG. 4, different types of the transparent first covers 22 are shown with different structures. The transparent cover 22a is a normal transparent cover with a smooth surface. Diffusion particles are added to the transparent cover 22b to scatter light. The transparent cover 22c defines concavities on its inner surface, which refract light and change the transmission direction of the light. The transparent cover 22d includes bumps on its inner surface, which diffuse light.

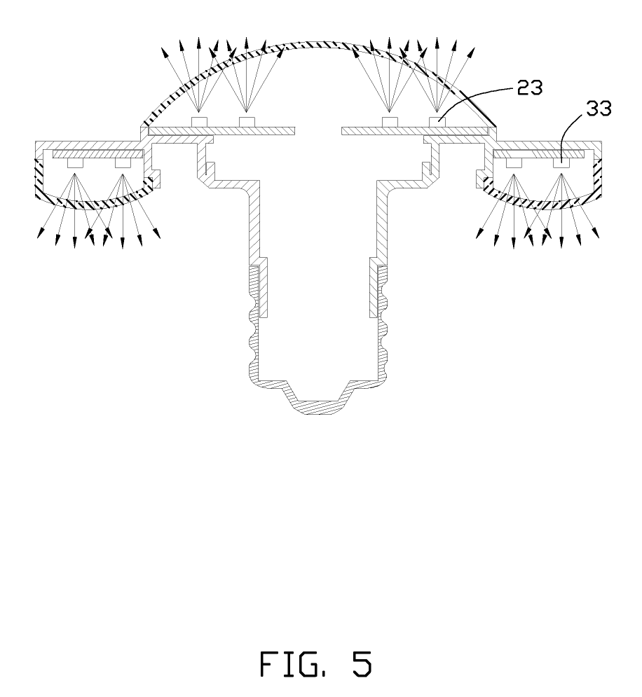

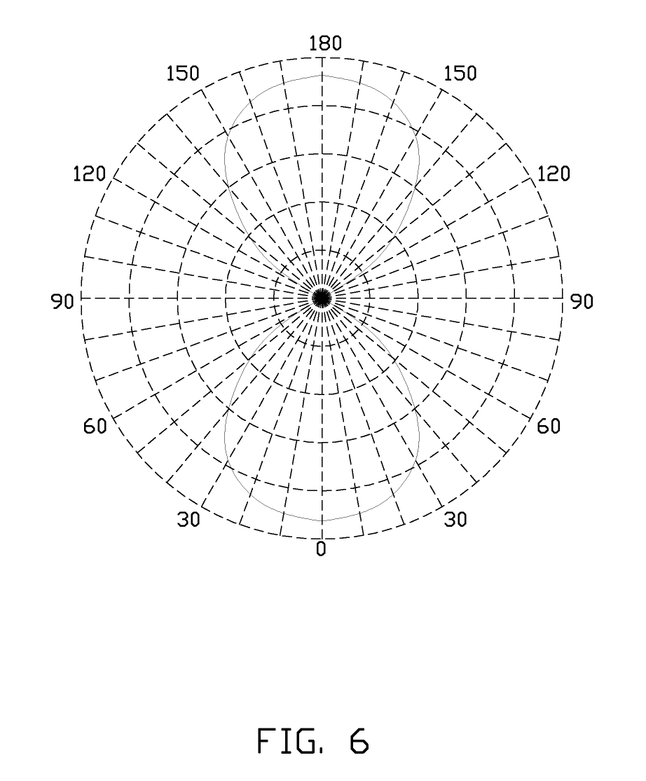

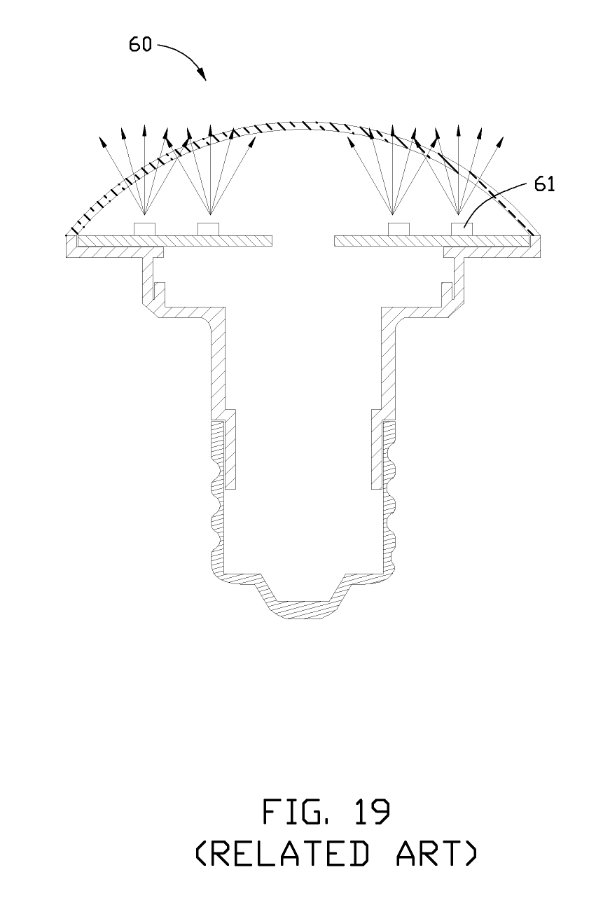

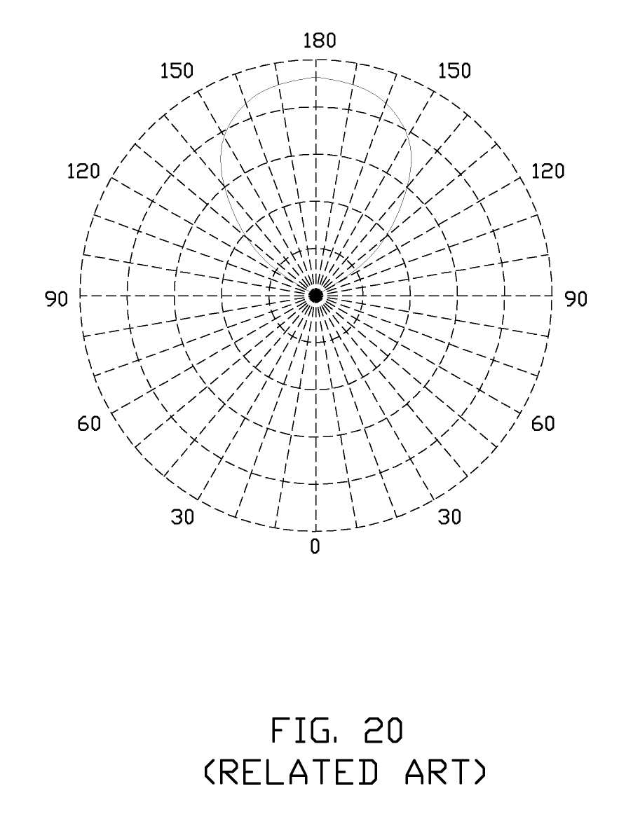

FIG. 19 shows a first kind of traditional LED illuminating device, the illuminating device includes a illuminating module 60, the illuminating module 60 includes front lighting LEDs 61. FIG. 20 is a light distribution curve chart of the illuminating device of FIG. 19. FIG. 5 shows an LED illuminating device according to the first embodiment, the illuminating device includes front lighting LEDs 23, 33. FIG. 6 is a light distribution curve chart of the illuminating device of FIG. 5. Comparing FIG. 20 with FIG. 6, we can see that the light divergence angle of the LED illuminating device in the FIG. 6 is twice the light divergence angle of the LED illuminating device in FIG. 20. That is, the LED illuminating device in FIG. 5 can illuminate twice the space illuminated by the LED illuminating device in FIG. 19.

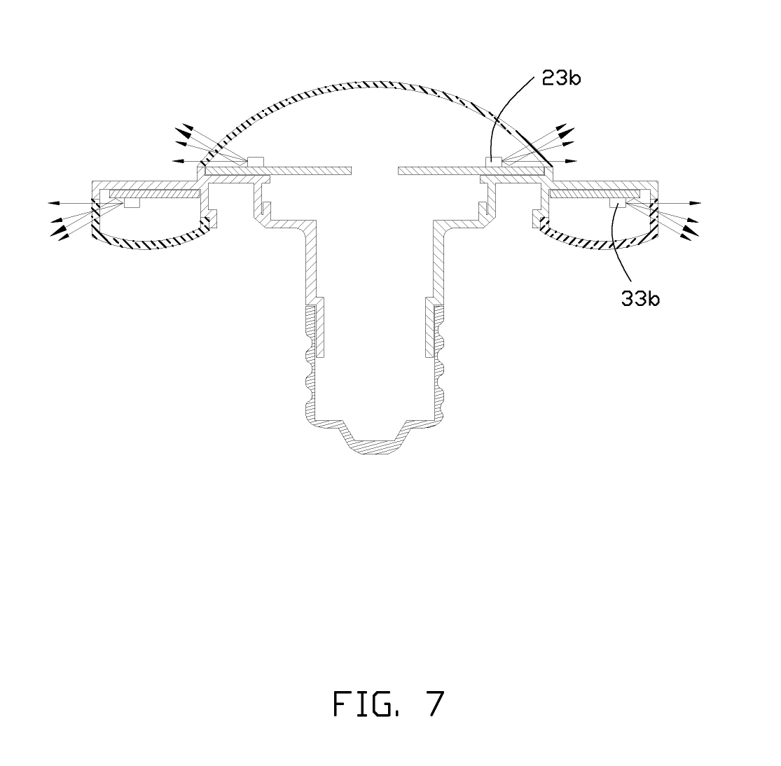

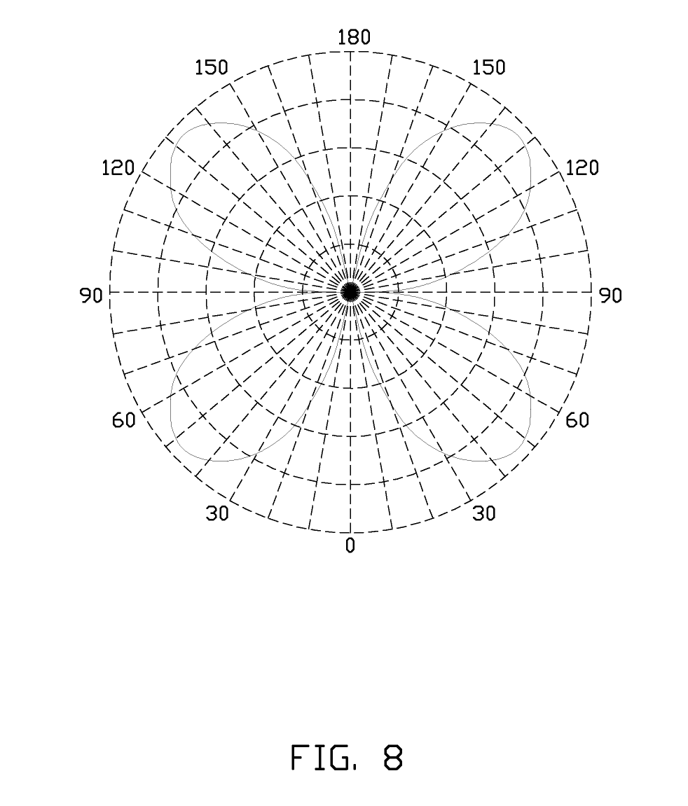

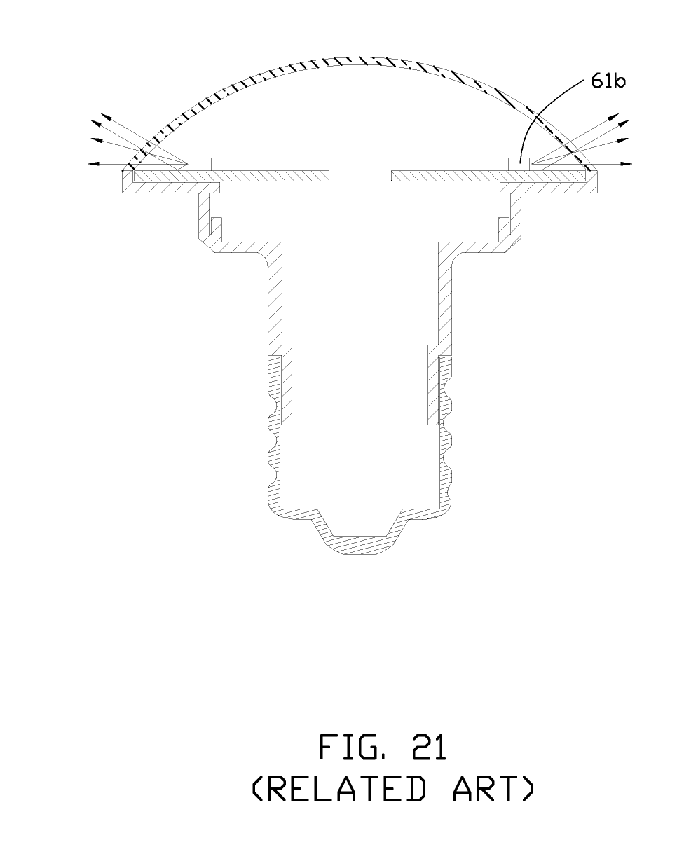

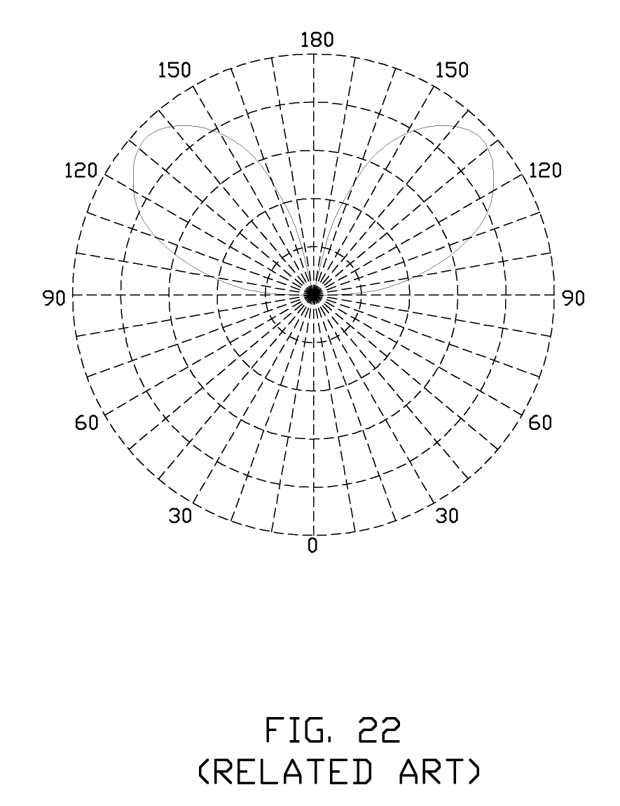

FIG. 21 shows a second kind of traditional LED illuminating device including side lighting LEDs 61b. FIG. 22 is a light distribution curve chart of the LED illuminating device of FIG. 21. FIG. 7 shows an illuminating device including side lighting LEDs 23b, 33b according to a second embodiment. FIG. 8 is a light distribution curve chart of the LED illuminating device of FIG. 7. Comparing FIG. 22 with FIG. 8, we can see that the light divergence angle of the LED illuminating device in the FIG. 21 is twice the light divergence angle of the LED illuminating device in FIG. 7. That is, the LED illuminating device in FIG. 21 can illuminate twice the space that is illuminated by the LED illuminating device in FIG. 7.

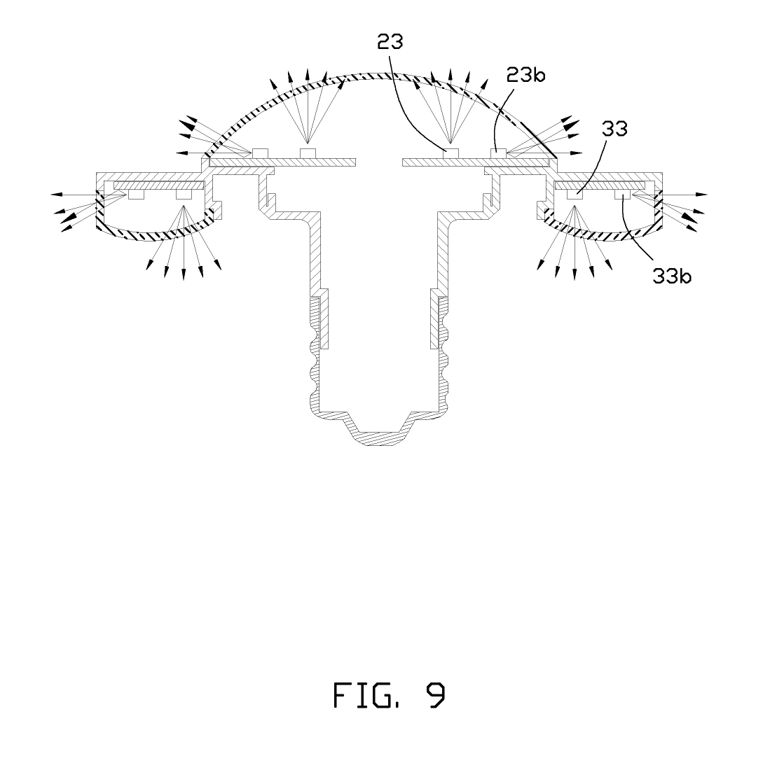

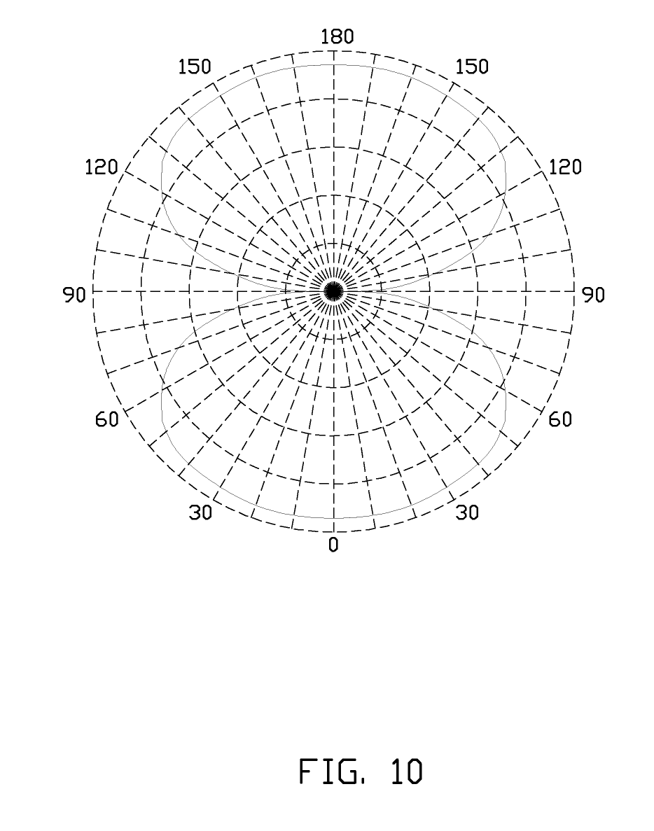

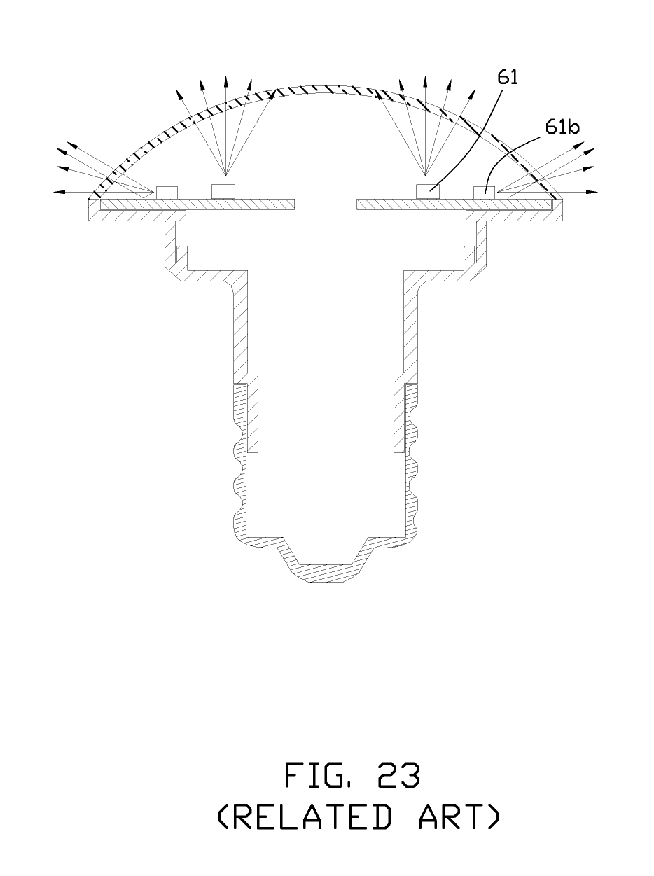

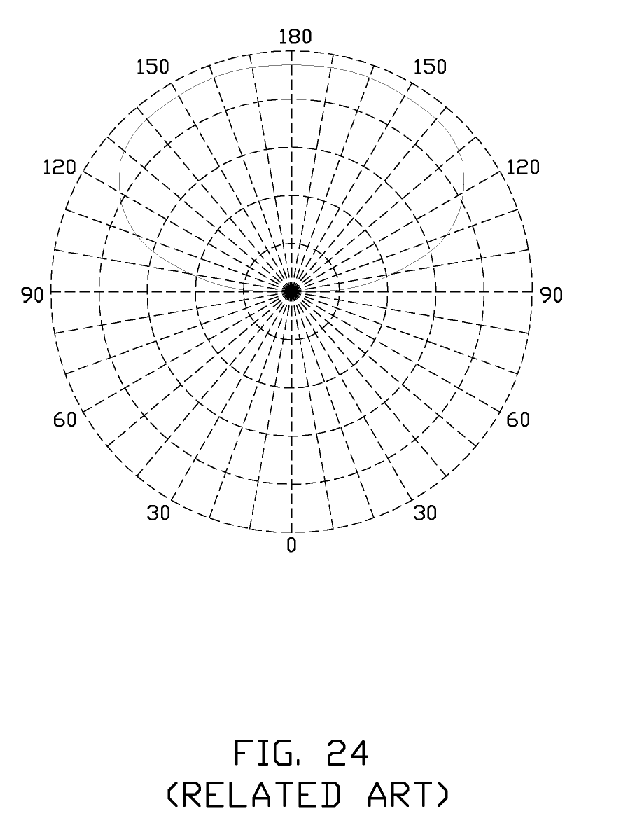

FIG. 23 shows a third kind of traditional LED illuminating device including front lighting LEDs 61 and side lighting LEDs 61b. FIG. 24 is a light distribution curve chart of the LED illuminating device of FIG. 23. FIG. 9 shows an illuminating device including front lighting LEDs 23, 33 and side lighting LEDs 23b, 33b according to a third embodiment. FIG. 10 is a light distribution curve chart of the LED illuminating device of FIG. 9. Comparing FIG. 24 with FIG. 10, we can see that the light divergence angle of the LED illuminating device in the FIG. 9 is twice the light divergence angle of the LED illuminating device in FIG. 23. That is, the LED illuminating device in FIG. 9 can illuminate twice the space illuminated by the LED illuminating device in FIG. 23. Furthermore, the light divergence angle of the LED illuminating device in FIG. 9 is almost equal to the light divergence angle of the incandescent lamp.

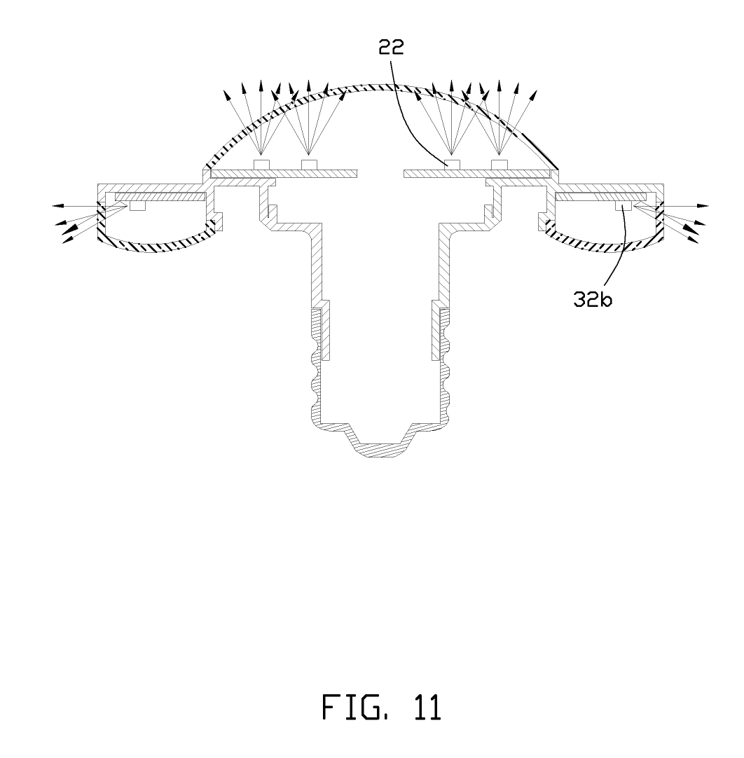

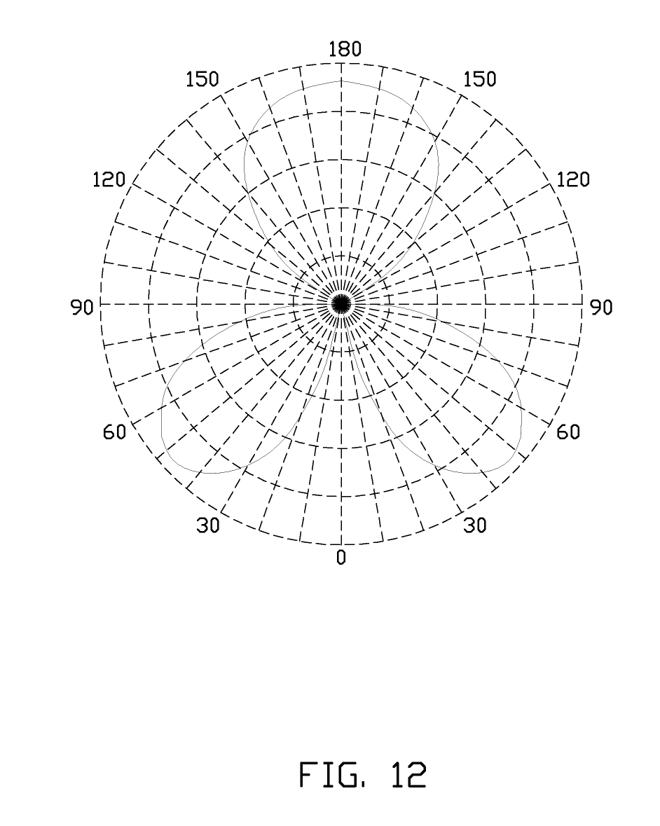

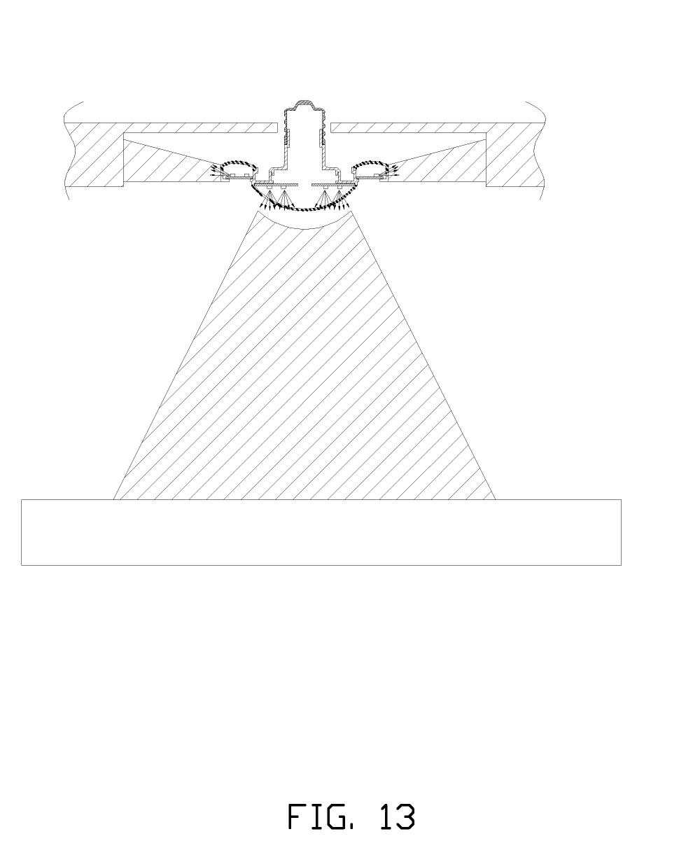

FIG. 11 shows an illuminating device according to a forth embodiment. In this embodiment, the first illuminating module 20 includes the front lighting LEDs 22, the second illuminating module 22 includes the side lighting LEDs 32b. FIG. 12 is a light distribution curve chart of the LED illuminating device of FIG. 11. We can see that the light distribution curve is dissymmetrical. FIG. 13 shows the illuminating device of FIG. 11 can be used as a bi-directional illuminating device, such as a ceiling lamp to illuminate the ceiling and the floor at the same time.

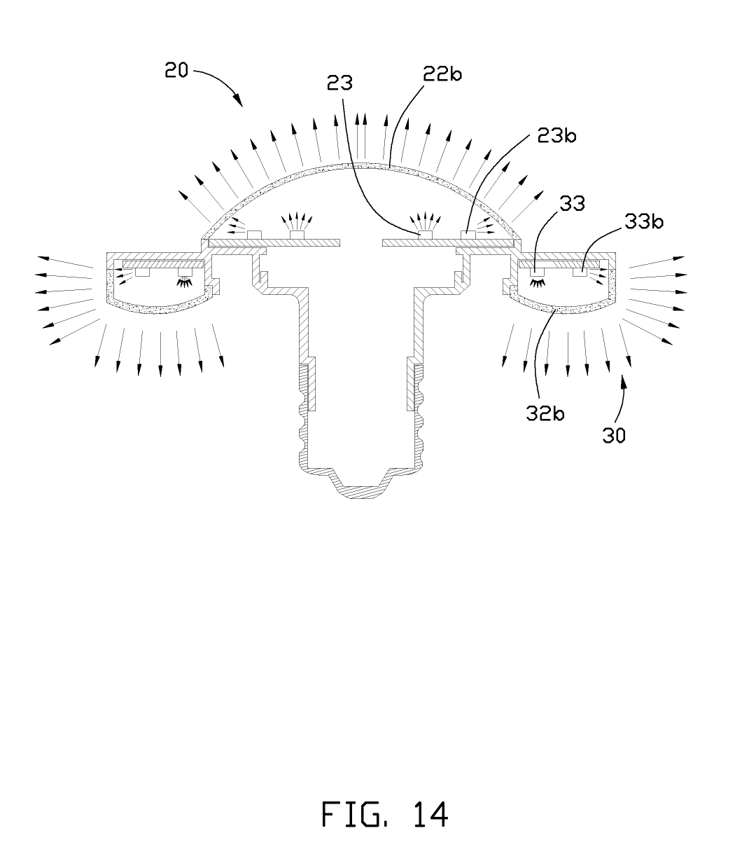

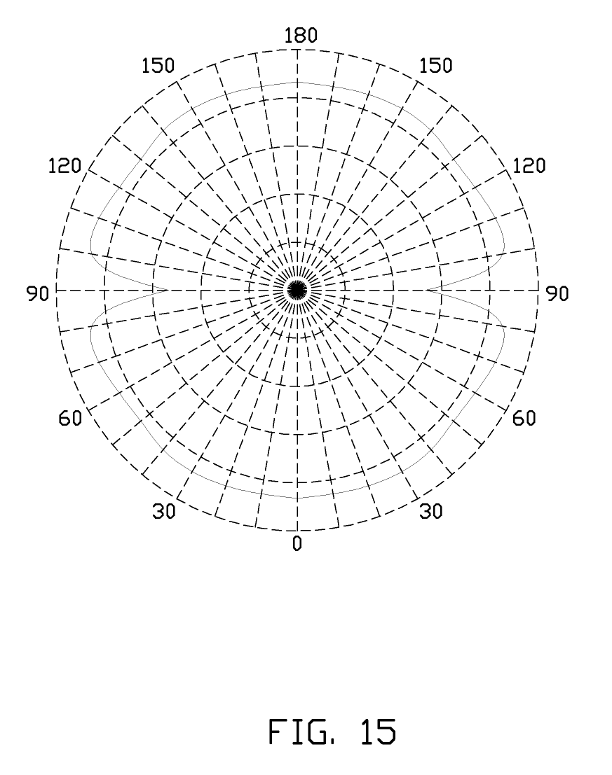

FIG. 14 shows an illuminating device according to a fifth embodiment. The illuminating device in FIG. 23 is similar to the illuminating device shown in FIG. 9, but different in adopting the transparent cover 22b, 32b with diffusion particles added. Thus, the light emitted is scattered by the transparent cover 22b, 32b. FIG. 15 is a light distribution curve chart of the LED illuminating device of FIG. 14. We can see that the light is almost distributed evenly in all the directions around the illuminating device.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An LED illuminating device comprising:
a first LED illuminating module comprising a first substrate and a first group of LEDs mounted on the first substrate;
a second LED illuminating module comprising a second substrate and a second group of LEDs mounted on the second substrate, wherein the first group of LEDs and the second group of LEDs face opposite directions, and the projections of the first substrate and the second substrate are spaced to each other; and
a connecting module connecting the first LED illuminating module with the second LED illuminating module.

2. The LED illuminating device of claim 1, further comprising a transparent first cover mounted on the first substrate and a transparent second cover mounted on the second substrate.

3. The LED illuminating device of claim 1, wherein the transparent first cover is one selected from the group consisting of a transparent cover with a smooth surface, a transparent cover with diffusion particles, a transparent cover defining concavities on its inner surface, and a transparent cover comprising bumps on its inner surface; and the transparent second cover is one selected from said group.

4. The LED illuminating device of claim 1, wherein the first group of LEDs and the second group of LEDs are front lighting LEDs or side lighting LEDs.

5. An LED illuminating device comprising:
a substrate; and
a first group of LEDs and a second group of LEDs respectively mounted on two opposite surfaces of the substrate, wherein the projections of the first group of LEDs and the second group of LEDs are spaced to each other.

6. The LED illuminating device of claim 5, wherein the first group of LEDs are located in the middle of the second group of LEDs.

7. The LED illuminating device of claim 5, further comprising a transparent first cover and a transparent second cover mounted on the two opposite surfaces of the substrate and covering the first group of LEDs and the second group of LEDs, respectively.

8. The LED illuminating device of claim 5, wherein the transparent first cover is one selected from the group consisting of a transparent cover with a smooth surfaces, a transparent cover with diffusion particles, a transparent cover defining concavities on its inner surface, and a transparent cover comprising bumps on its inner surface; and the transparent second cover is one selected from said group.

9. The LED illuminating device of claim 5, wherein the first group of LEDs and the second group of LEDs are front lighting LEDs or side lighting LEDs.
